(19) United States
(12) Patent Application Publication
(10) Pub. No.: US 2008/0235976 A1
(43) Pub. Date: Oct. 2, 2008

(54) DRYING APPARATUS AND DRYING METHOD

(75) Inventor: BOR-YUAN HSIAO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/860,495

(22) Filed: Sep. 24, 2007

(30) Foreign Application Priority Data
Mar. 29, 2007 (CN) 200710200355.5

(51) Int. Cl. F26B 19/00

(52) U.S. Cl. 34/60

(57) ABSTRACT

A drying apparatus (100) for drying a plastic element with water membrane formed thereon includes a tray (10), a sonicator (20) and a dryer (30). The tray (10) is configured for holding the plastic element (40) to be treated. The sonicator (20) is attached to the tray (10) for rupturing the water membrane formed on the plastic element (40). The dryer (30) is disposed corresponding to the tray (10) for providing hot air for drying the plastic element (40).

### BACKGROUND

1. Technical Field

The invention relates generally to drying apparatus and methods, and particularly to a drying apparatus and associated method for a plastic element.

2. Description of Related Art

Currently, with the ongoing development of multimedia technology, image capture devices, such as digital cameras, mobile phone cameras, etc., are now in widespread. Such device has becoming an indispensable product for people in modern life.

A camera includes at least one lens module and an image sensor module in alignment with the lens module. The lens module is composed of a variety of elements, such as a barrel, a holder, and a spacer. These elements are generally manufactured by injection molding. During the injection molding process, an oil release agent is used to aid in the separation of the mold from the molded elements. However, such oil release agent is likely to remain on surfaces of the molded elements. Therefore, before assembling the molded elements into the lens module, a washing and a drying process are required for removing the oil release agent, as well as other chemicals and containments on the molded elements.

As mentioned above, the barrel of the lens module, for example, has an aperture defined thereon. During the washing process, because the aperture is very small, water membrane is easily formed on the aperture. Additionally, the water membrane will block hot air provided in the drying process to pass through the aperture into inside of the barrel. Therefore, the time needed to dry the barrel completely is increased. That is, the drying efficiency is accordingly reduced.

What is needed, therefore, is a drying apparatus and a drying method for drying the plastic elements efficiently.

### SUMMARY

A drying apparatus for drying a plastic element with water membrane formed thereon is provided. In one present embodiment, the drying apparatus includes a tray, a sonicator, and a dryer. The tray is configured for holding the plastic element in place. The sonicator is attached to the tray for rupturing the water membrane formed on the plastic element. The dryer is disposed corresponding to the tray to provide hot air for drying the plastic element.

A drying method for drying a plastic element with water membrane formed thereon is provided. In one present embodiment, the drying method includes the steps described as follows. The plastic element is placed on a tray. An ultrasonic vibration is applied to the plastic element so as to rupture water membrane formed thereon. The plastic element is dried with hot air.

Advantages and novel features of the present drying apparatus and drying method will become more apparent from the following detailed description of preferred embodiments when taken in conjunction with the accompanying drawings.

### BRIEF DESCRIPTION OF THE DRAWINGS

The components in the drawing are not necessarily drawn to scale, the emphasis instead being placed upon clearly illustrating the principles of the present invention.

FIG. 1 is a schematic sectional view of a drying apparatus in accordance with a present embodiment.

Corresponding reference characters indicate corresponding parts. The exemplifications set out herein illustrate at least one preferred embodiment of the present drying apparatus and drying method, in one form, and such exemplifications are not to be construed as limiting the scope of the invention in any manner.

### Detailed Description of the Embodiment

Reference will now be made to the drawings to describe embodiments of the present drying apparatus and drying method in detail.

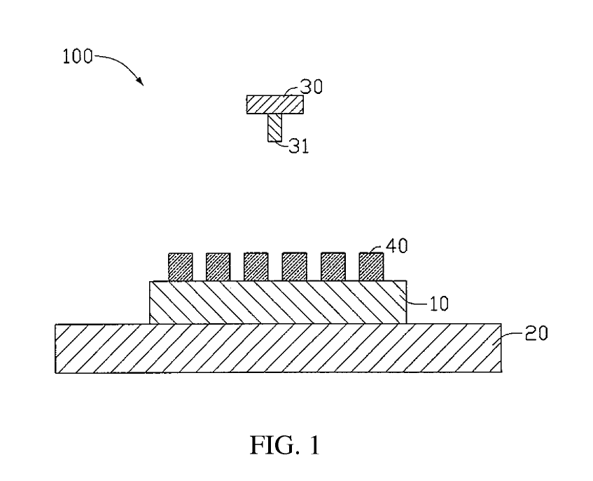

Referring to FIG. 1, a drying apparatus 100 in accordance with a present embodiment, is shown. The drying apparatus 100 is used to dry a plastic element. In the present embodiment, there are a variety of the plastic elements, such as barrels, holders, or spacers, to be treated.

The drying apparatus 100 includes a tray 10, a sonicator 20 and a dryer 30. The tray 10 is used to hold the plastic elements. The sonicator 20 (i.e. an ultrasonic oscillation device) is attached to the tray 10. In the present embodiment, the tray 10 is disposed on the sonicator 20. The dryer 30 is disposed corresponding to the tray 10.

In the present embodiment, the plastic elements 40 are placed on the tray 10 in a row or in multiple rows. In addition, the plastic elements 40 are placed in an area where the air provided by the dryer 30 can be reached. Hot air is generated from the dryer 30 to dry the plastic elements 40. The plastic elements 40 can be in different shapes.

During the washing process, because openings of the plastic elements 40, e.g. apertures of the barrels, are very small, water membranes are easily formed on openings. In the present embodiment, the sonicator 20 is used to rupture water membranes formed on the plastic elements 40. When the sonicator 20 is use/operated, an ultrasound at a predetermined frequency is generated. The ultrasound energy is transmitted from the sonicator 20 to the tray 10. Consequentially, the tray 10 is vibrated and the plastic elements 40 placed on the tray 10 are agitated. As a result, the water membranes formed on the openings of the plastic elements 40 will be ruptured effectively. Therefore, hot air supplied by the dryer 30 can effectively pass through and reach insides of the plastic elements 40. The time required for drying the plastic elements 40 completely is shortened. In addition, due to the ultrasound energy with high-frequency and low-amplitude, the plastic elements 40 will remain in position on the tray 10 during the operation of the sonicator 20.

In the present embodiment, the dryer 30 can be an air blower. In such case, the dryer 30 has a blower nozzle 31 facing the plastic elements on the tray 10 to blow hot air. Temperature of hot air supplied by the dryer 30 is in an approximate range from 40° C. to 70° C. Alternatively, the dryer 30 can be a dry-jet. In this case, the dry-jet can be disposed directly above the tray 10. However, the dryer 30 in the present embodiment is not necessary limited to what is mentioned above.

Additionally, a drying method for drying a plastic element with water membrane formed thereon in accordance with a present embodiment includes the steps:
(a): placing the plastic element on a tray;
(b): applying an ultrasonic vibration to the plastic element so as to disrupt the water membrane formed thereon; and
(c): drying the plastic element with hot air.

Each step of the present method is described in greater detail below.

In step (a), the plastic element 40 to be treated is placed on the tray 10 of a drying apparatus. In the present embodiment, because structure, functions and characteristics of the drying apparatus is similar to the drying apparatus 100 mentioned in the previous embodiment, the detailed description of the drying apparatus is omitted for sake of conciseness. In the present embodiment, there are a variety of the plastic elements 40 to be dried by the drying apparatus 100. The plastic elements 40 are placed within an effective working area of the tray 10.

Step (b) is provided to rupture the water membranes formed on the plastic elements 40. In the present embodiment, the water membranes are formed, in particular, around openings of the plastic elements 40 after rinsing the plastic elements 40 with water-wash process. The sonicator 20 of the drying apparatus 100 is utilized to generate ultrasound so as to apply the ultrasonic vibration to the plastic elements 40, thereby the water membranes formed on the plastic elements 40 can be ruptured. In such case, the operating time of the sonicator 20 depends on the number of the plastic elements on the tray 10. That is, the operating time of the sonicator 20 is controllable.

In step (c), the drying process of the plastic elements 40 is required to be performed in a dustless environment. The drier 30 of the drying apparatus 100 is utilized to blow hot air for drying the plastic elements 40 until they are dry completely. The desired temperature of the air generated from the drier 30 should be in an approximate range from 40° C. to 70° C.

Alternatively, step (b) and step (c) can be performed simultaneously. That is, when the sonicator 20 is operating, the plastic elements 40 can be at the same time dried by the dryer 30. Thus, the time required for drying the plastic elements 40 is reduced effectively.

In summary, the drying apparatus and the drying method in the present embodiments are by way of sonicating the plastic elements to disrupt the water membranes before drying them or by way of sonicating the plastic elements when they are being dried. For the conventional drying method, it takes about 20 minutes to 30 minutes to dry up to 3000 plastic elements. As for the present drying method, it only takes about 5 minutes to 10 minutes to dry the same amount of plastic elements. Therefore, the time required for drying the plastic elements is reduced effectively.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A drying apparatus for drying a plastic element with water membrane formed thereon, the drying apparatus comprising:
a tray configured for holding the plastic element to be treated; a sonicator attached to the tray for rupturing the water membrane formed on the plastic element; and
a dryer disposed corresponding to the tray for providing hot air for drying the plastic element.

2. The drying apparatus as claimed in claim 1, wherein the dryer is a dry jet or an air blower.

3. The drying apparatus as claimed in claim 1, wherein the hot air with a temperature thereof is in an approximate range from 40° C. to 70° C.

4. The drying apparatus as claimed in claim 1, wherein the tray is disposed on the sonicator.

5. The drying apparatus as claimed in claim 1, wherein the sonicator is an ultrasonic oscillation device.

6. A drying method for drying a plastic element with water membrane formed thereon, the method comprising the steps of:
placing the plastic element on a tray;
applying an ultrasonic vibration to the plastic element so as to rupture the water membrane formed thereon; and
drying the plastic element with hot air.

7. The method as claimed in claim 6, wherein the hot air with a temperature thereof is in an approximate range from 40° C. to 70° C.
